(19) United States
(12) Patent Application Publication
(10) Pub. No.: US 2007/0260803 A1
(43) Pub. Date: Nov. 8, 2007

(54) DATA PROCESSING SYSTEM AND METHOD

(75) Inventor: Jing Jung HUANG, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: REALTEK SEMICONDUCTOR CORP., Hsinchu (TW)

(21) Appl. No.: 11/741,099

(22) Filed: Apr. 27, 2007

(30) Foreign Application Priority Data
May 4, 2006 (TW) 095115841

(51) Int. Cl. G06F 13/20

(52) U.S. Cl. 710/313

(57) ABSTRACT

A data processing system includes a central processing unit having a cache memory, a main memory for storing data which will be processed by the central processing unit, and an agent circuit having a data buffer, coupled to the central processing unit; wherein the agent circuit actively reads the data from the main memory to the data buffer such that when a cache miss occurs, the central processing unit can obtain the data straight from the data buffer whereby increasing its MIPS rate.

### CROSS REFERENCE TO RELATED APPLICATION

This application claims the priority benefit of Taiwan Patent Application Serial Number 095115841, filed on May 4, 2006, the full disclosure of which is incorporated herein by reference.

### BACKGROUND OF THE INVENTION

1. Field of the Invention

This invention generally relates to a data system, and more particularly to a data processing system and method.

2. Description of the Related Art

FIG. 1 shows a circuit block diagram of a conventional data processing system 10. The data processing system 10 includes a central processing unit (CPU) 12 having a cache memory 22, a main memory 14, a plurality of input/output (I/O) devices 16, a shared bus 18, and a bus arbiter 20. The central processing unit 12, the main memory 14 and the plurality of I/O devices 16 are connected to the shared bus 18, and transmit data through the shared bus 18. The bus arbiter 20 is used for arbitrating the right for using the shared bus 18 among the central processing unit 12 and the plurality of I/O devices 16.

Now referring to FIG. 1 and FIG. 2, when a cache miss occurs in the cache memory 22, the central processing unit 12 sends a bus request signal REQ to the bus arbiter 20 for requesting the right to use the shared bus 18. Afterwards, the bus arbiter 20 sends a bus grant signal GNT after a period of time Ti to respond the bus request signal REQ, whereby granting the central processing unit 12 to obtain the right for using the shared bus 18. Finally, the central processing unit 12 is able to use the shared bus 18 to read the required data D from the main memory 14 after a period of time T2 from receiving the bus grant signal GNT. Therefore, the MIPS rate (million instructions per second rate) of the central processing unit 12 is decreased and the executing efficiency thereof is affected.

In order to increase the MIPS rate of the central processing unit 12, the following conventional methods have been implemented.

One conventional method is to increase the length of the cache line in the cache memory 22 thereby reducing cache miss ratio. However, due to the increase of the length of the cache line in the cache memory 22, more data D is required to be read as a cache miss occurs such that the period of time T2 (as shown in FIG. 2) for reading the data D from the shared bus 18 and then writing it into the cache line becomes longer.

Another conventional method is to dispose a level 2 (L2) cache memory in the data processing system 10 thereby increasing the MIPS rate of the central processing unit 12. However, the disposition of the L2 cache memory may not only increase the manufacturing cost of the data processing system 10 but also increase the circuitry complexity of the same. Further, if a cache miss also occurs in the L2 cache memory, the central processing unit 12 cannot process or execute the required data until the required data read from the main memory 14 is written respectively into the cache lines of the L2 cache memory and the cache memory 22.

### SUMMARY OF THE INVENTION

It is an object of the present invention to provide a data processing system with an agent circuit for solving the above-mentioned problems existing in the prior art.

In order to achieve the above object, the present invention provides a data processing system, which comprises a central processing unit having a cache memory, a main memory for storing data which will be processed by the central processing unit, and a buffer circuit having a data buffer wherein the buffer circuit can be considered as an agent of the central processing unit and actively reads the data from the main memory to the data buffer such that when a cache miss occurs, the central processing unit can obtain the data straight from the data buffer whereby increasing its MIPS rate.

### BRIEF DESCRIPTION OF THE DRAWINGS

Other objects, advantages, and novel features of the present invention will become more apparent from the following detailed description when taken in conjunction with the accompanying drawings.

FIG. 1 shows a circuit block diagram of a conventional data processing system.

FIG. 2 shows a timing diagram of the control signals REQ, GNT and the data D in the data processing system shown in FIG. 1.

FIG. 3 shows a circuit block diagram of a data processing system according to the first embodiment of the present invention.

FIG. 4 shows a timing diagram of the control signals REQ, REQ1, GNT, GNT 1 and the data signal Da in the data processing system shown in FIG. 3.

FIG. 5 shows a circuit block diagram of a data processing system according to the second embodiment of the present invention.

FIG. 6 shows a timing diagram of the control signals REQ, REQ1, GNT, GNT1 and the data signal Da in the data processing system shown in FIG. 5.

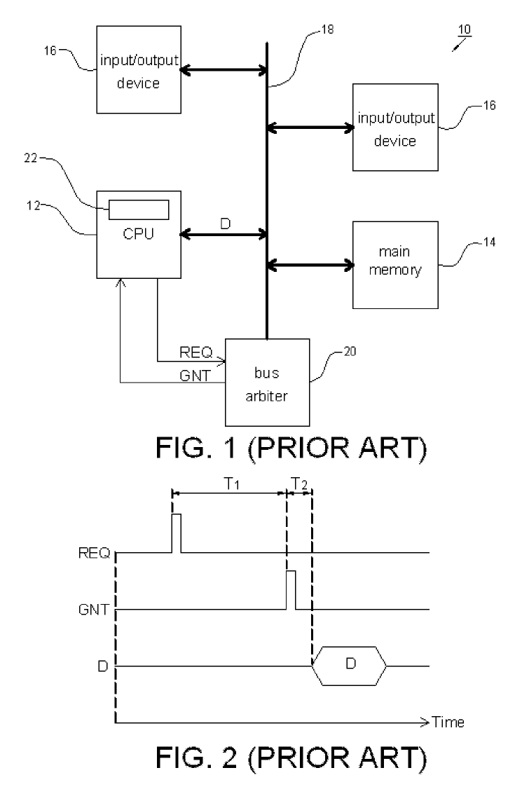

### DETAILED DESCRIPTION OF THE PREFERRED EMBODIMENT

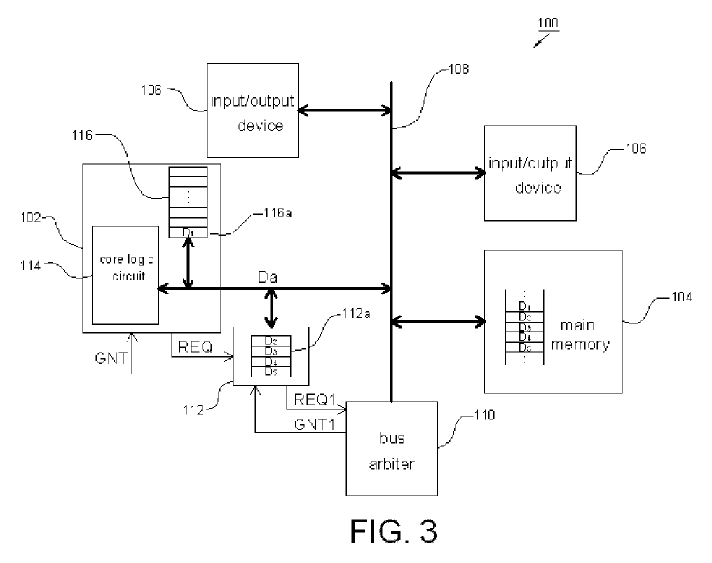

FIG. 3 shows a circuit block diagram of a data processing system 100 according to the first embodiment of the present invention. The data processing system 100 includes a central processing unit (CPU) 102, a main memory 104, a plurality of input/output (I/O) devices 106, a shared bus 108, a bus arbiter 110, and a buffer circuit 112. The central processing unit 102, the main memory 104 and the plurality of I/O devices 106 are respectively connected to the shared bus 108, and transmit data through the shared bus 108. The central processing unit 102 has a core logic circuit 114 and a cache memory 116, and can be implemented by any processor which has data processing function, e.g. a central processing unit (CPU) or a microprocessor. The main memory 104 can be implemented by any memory unit or any dynamic random access memory (DRAM), e.g. a double data rate DRAM (DDR DRAM) or a synchronous DRAM (SDRAM). The bus arbiter 110 is used for arbitrating the right for using the shared bus 108 among the central processing unit 102 and the plurality of I/O devices 106. The buffer circuit 112 has a data buffer 112a for temporarily storing data which will be processed by the central processing unit 102.

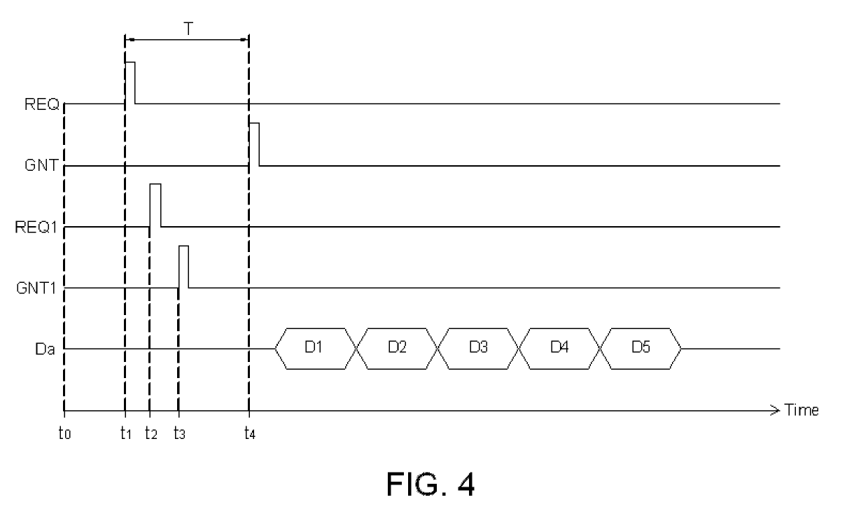

FIG. 4 shows a timing diagram of the control signals REQ, REQ1, GNT, GNT 1 and the data signal Da in the data processing system 100 shown in FIG. 3. For more clearly illustrating the operation of the data processing system 100, it is assumed that a cache miss occurs when the central processing unit 102 reads data D1, and data D1, D2, D3, D4 and D5 are stored in five continuous addresses of the main memory 104 as shown in FIG. 3.

Now referring to FIG. 3 and FIG. 4, when a cache miss occurs at time t0, the central processing unit 102 will send a bus request signal REQ at time t1 to the circuit buffer 112, after receiving the bus request signal REQ, the circuit buffer 112 will send a bus request signal REQ1 at time t2 to the bus arbiter 110 for requesting the right for using the shared bus 108. Afterwards, the bus arbiter 110 will send a bus grant signal GNT1 at time t3 to respond the bus request signal REQ1 thereby granting the buffer circuit 112 to obtain the right for using the shared bus 108, meanwhile the buffer circuit 112 will send a bus grant signal GNT at time t4 to the central processing unit 102 such that the central processing unit 102 can receive a message of being granted to use the shared bus. After the buffer circuit 112 receives the bus grant signal GNT1, the buffer circuit 112 will read the data D1, D2, D3, D4 and D5 from the main memory 104, and then store the data D1 into one of the cache lines 116a of the cache memory 116 and the data D2, D3, D4 and D5 into the data buffer 112a.

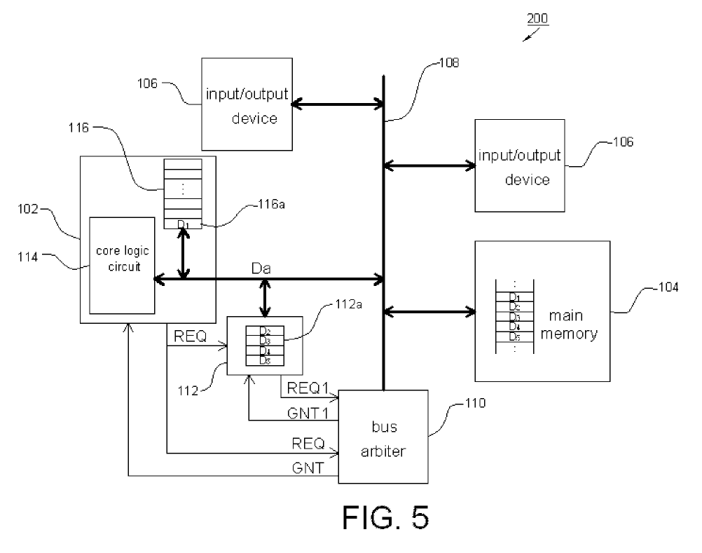

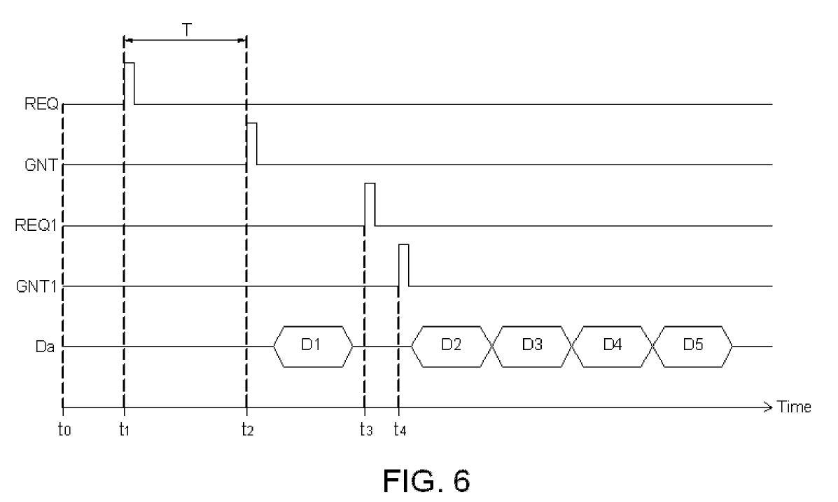

FIG. 5 and FIG. 6 show a circuit block diagram and a timing diagram of its relative signals of the data processing system 200 according to the second embodiment of the present invention. In FIG. 5, the elements, which are identical to those shown in FIG. 3, are indicated by the same numerals and will not be described in detail. The main difference between the data processing system 200 and the data processing system 100 shown in FIG. 3 is that the bus request signal REQ is sent to the bus arbiter 110 and the bus circuit 112 at the same time in the data processing system 200, and the bus grant signal GNT is generated by the bus arbiter 110 and then sent to the central processing unit 102.

Now referring to FIG. 5 and FIG. 6, when a cache miss occurs at time t0, the central processing unit 102 will send a bus request signal REQ at time t1 to the bus arbiter 110 and the buffer circuit 112 at the same time, and then the bus arbiter 110 will send a bus grant signal GNT at time t2 to respond the bus request signal REQ for granting the central processing unit 102 to obtain the right for using the shared bus 108. Afterward, after the central processing unit 102 receives the bus grant signal GNT, it will read data D1 from the main memory 104 and then store the data D1 into one of the cache lines 116a of the cache memory 116. When the central processing unit 102 sends a bus request signal REQ to the bus arbiter 110 and then obtains the data D1, the buffer circuit 112 will send a bus request signal REQ1 at time t3 to the bus arbiter 110 whereby requesting the right for using the shared bus 108. Next, the bus arbiter 110 will send a bus grant signal GNT1 at time t4 to respond the bus request signal REQ1 for granting the buffer circuit 112 to obtain the right for using the shared bus 108. When the buffer circuit 112 receives the bus grant signal GNT1, the buffer circuit 112 will read data D2, D3, D4 and D5 from the main memory 104 through the shared bus 108, and then store the data D2, D3, D4 and D5 into the data buffer 112a.

In the above embodiment, each data D1, D2, D3, D4 and D5 may contain several instructions or data within a program and have a size equal to the size of each cache line 116a of the cache memory 116. When the central processing unit 102 obtains the data D1, the core logic circuit 114 will begin to process (i.e. execute or compute) the data D1. After the core logic circuit 114 finishes processing the data D1, if the next required data is contained in one of the data D2, D3, D4 and D5 and can not be found in the cache memory 116, then the central processing unit 102 will read the data D2, D3, D4 and/or D5, which contains the next required data, from the data buffer 112a of the buffer circuit 112 to the cache memory 116. In this manner, the central processing unit 102 has no need to waste time T, i.e. waiting time, on reading data from the main memory 104, whereby increasing its MIPS rate.

In addition, in this embodiment, the buffer circuit 112 may be considered as an agent of the central processing unit. During the time the core logic circuit 114 executes or computes the data D1, the buffer circuit 112 can actively send the bus request signal REQ1 to the bus arbiter 110 for requesting the right for using the shared bus 108 to read the data D2, D3, D4 and D5 from the main memory 104 and then store them into the data buffer 112a. Therefore, the central processing unit 102 has no need to waste time for waiting the data D2, D3, D4 and D5 to be stored into the data buffer 112a before executing or computing the data D1.

In an alternative embodiment of the present invention, during the time the core logic circuit 114 executes or computes data D1, the buffer circuit 112 can successively send several bus request signals REQ1 to the bus arbiter 110 and receive several bus grant signals GNT1 from the bus arbiter 110 whereby using the shared bus 108 at different time to successively read data D2, D3, D4 and D5 from the main memory 104 and then write them into the data buffer 112a.

The buffer circuit 112 according to the embodiment of the present invention can be disposed within a system bridge circuit and a memory controller (not shown). The system bridge circuit is an interface circuit disposed between a central processing unit and a shared bus for transforming the formats of signals transmitted therebetween. In addition, the data buffer 112a according to the embodiment of the present invention has a size larger than that of a single cache line 116a of the cache memory 116; therefore, when a cache miss occurs, the central processing unit 102 can have a higher probability of finding the required data in the data buffer 112a whereby increasing its MIPS rate.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A data processing system, comprising:
a shared bus;
a bus arbiter for arbitrating the right for using the shared bus;
a memory unit being coupled to the shared bus and storing a first data and a second data;
a central processing unit having a cache memory, and generating a first bus request signal when a cache miss occurs in the cache memory; and
a buffer circuit having a data buffer and sending a second bus request signal, after the first bus request signal being received, to the bus arbiter for storing the first data into the cache memory and the second data into the data buffer through the shared bus.

2. The data processing system as claimed in claim 1, wherein the central processing unit first processes the first data, and then reads the second data from the data buffer and processes the second data.

3. The data processing system as claimed in claim 2, wherein the central processing unit further has a core logic circuit for processing the first data and the second data.

4. The data processing system as claimed in claim 1, wherein the buffer circuit is implemented in a system bridge circuit.

5. The data processing system as claimed in claim 1, wherein the cache memory has a plurality of cache lines for temporarily storing data.

6. The data processing system as claimed in claim 5, wherein the first data is temporarily stored in one of the cache lines.

7. The data processing system as claimed in claim 5, wherein the size of the data buffer is larger than that of each cache line.

8. The data processing system as claimed in claim 1, wherein the bus arbiter generates a bus grant signal to respond the second bus request signal.

9. The data processing system as claimed in claim 1, wherein the first data and the second data are stored in two continuous addresses in the memory unit.

10. The data processing system as claimed in claim 1, wherein the buffer circuit is implemented in a memory controller.

11. A data processing system, comprising:
a shared bus;
a bus arbiter for arbitrating the right for using the shared bus;
a memory unit being coupled to the shared bus and storing a first data and a second data;
a central processing unit having a cache memory, and generating a first bus request signal when a cache miss occurs in the cache memory; and
a buffer circuit having a data buffer and actively sending a second bus request signal, when the central processing unit processes the first data, to the bus arbiter for storing the second data into the data buffer through the shared bus.

12. The data processing system as claimed in claim 11, wherein the central processing unit further reads the second data from the data buffer and processes the second data.

13. The data processing system as claimed in claim 12, wherein the central processing unit further has a core logic circuit for processing the first data and the second data.

14. The data processing system as claimed in claim 11, wherein the buffer circuit is implemented in a system bridge circuit.

15. The data processing system as claimed in claim 11, wherein the cache memory has a plurality of cache lines for temporarily storing data.

16. The data processing system as claimed in claim 15, wherein the first data is temporarily stored in one of the cache lines.

17. The data processing system as claimed in claim 15, wherein the size of the data buffer is larger than that of each cache line.

18. The data processing system as claimed in claim 11, wherein the bus arbiter generates a bus grant signal to respond the second bus request signal.

19. The data processing system as claimed in claim 11, wherein the first data and the second data are stored in two continuous addresses in the memory unit.

20. The data processing system as claimed in claim 11, wherein the buffer circuit is implemented in a memory controller.
